(19) United States
(12) Patent Application Publication
(10) Pub. No.: US 2012/0169124 A1
(43) Pub. Date: Jul. 5, 2012

(54) OUTPUT CIRCUIT FOR POWER SUPPLY SYSTEM

(75) Inventors: Takeshi NAKASHIMA, Osaka (JP); Ryuzo HAGIHARA, Osaka (JP); Kenji UCHIHASHI, Osaka (JP)

(73) Assignee: SANYO ELECTRIC CO., LTD., Osaka (JP)

(21) Appl. No.: 13/416,170

(22) Filed: Mar. 9, 2012

Related U.S. Application Data
(62) Division of application No. PCT/JP2011/069271, filed on Aug. 26, 2011.

(30) Foreign Application Priority Data
Oct. 15, 2010 (JP) 2010-232319

(51) Int. Cl. H02J 9/00

(52) U.S. Cl. 307/64

(57) ABSTRACT

A power supply system is provided with an output terminal unit including a common output terminal, which, when an amount of stored charge in lithium-ion secondary batteries capable of supplying discharge power as a first DC power to a DC load is greater than a predetermined first reference value, supplies to the DC load the first DC power from the lithium-ion secondary batteries and which, when the amount of stored charge is less than the first reference value, supplies to the DC load a second DC power obtained by converting AC power from a system power supply using an AC-DC converter circuit.

### CROSS REFERENCE TO RELATED APPLICATION

The present application is a continuation application of International Application No. PCT/JP2011/069271, filed Aug. 26, 2011, the entire contents of which are incorporated herein by reference and priority to which is hereby claimed. The PCT/JP2011/069271 application claimed the benefit of the date of the earlier filed Japanese Patent Application No. 2010-232319, filed Oct. 15, 2010, the entire contents of which are incorporated herein by reference, and priority to which is hereby claimed.

### TECHNICAL FIELD

The present invention relates to an output circuit for power supply system, and more particularly to a power supply system output circuit for supplying power to a load.

### BACKGROUND ART

In recent years, consideration have been given to achieving effective use of energy by employing a secondary battery. For example, while solar cell modules are actively developed as a source of environment-friendly clean energy, since a solar cell module for converting sunlight into electric power does not include a power storage function, it may be used in combination with a secondary battery.

As related art of the present invention, for example, Patent Literature 1 discloses a solar cell power supply device comprising a solar cell, a plurality of secondary batteries charged by the solar cell, charge switches which are connected between the respective secondary batteries and the solar cell and which control charging of the secondary batteries, discharge switches connected between the respective secondary batteries and a load, and a control circuit for controlling the charge switches and the discharge switches. Patent Literature 1 describes that the control circuit identifies an order of priority of the secondary batteries to be charged by controlling the plurality of charge switches, and performs control such that a secondary battery having a higher order of priority is charged before a secondary battery having a lower order of priority, and, after the secondary battery having a higher order of priority is charged to a predetermined capacity level, the secondary battery having a lower order of priority is charged.

### Prior Art Literature

### Patent Literature

Patent Literature 1: JP 2003-111301 A

### SUMMARY OF THE INVENTION

### Problems Addressed by the Invention

In a case in which power generated by a solar cell module is stored by charging a secondary battery and discharged power is supplied to an external load, it is desired that AC (alternating current) power from a system power supply or the like is supplied to the external load according to necessity.

An object of the present invention is to provide a power supply system output circuit which enables supply of AC power from a system power supply or the like to an external load in accordance with a charged state of a secondary battery.

### Means for Solving the Problems

A power supply system output circuit according to the present invention includes a first power path for supplying discharge power being discharged from a secondary battery as a first DC (direct current) power, a second power path for supplying a second DC power obtained by converting AC power from an AC power supply source using an AC-DC converter circuit, and an output terminal unit which is connected to the first power path and the second power path and which includes a common output terminal for supplying the first DC power or the second DC power to a DC load via a DC-DC converter circuit. The first power path supplies the first DC power to the output terminal unit when an amount of stored charge in the secondary battery is greater than a predetermined first reference value, and the second power path supplies the second DC power to the output terminal unit when the amount of stored charge is less than the first reference value.

### Advantages of the Invention

According to the above-described arrangement, the first DC power, which is the discharge power, is supplied to the DC load when the amount of stored charge in the secondary battery is greater than the predetermined first reference value, and when the amount of stored charge in the secondary battery becomes less than the predetermined first reference value, the second DC power output from the AC-DC converter circuit is supplied to the DC load. As such, power from the AC power supply source is converted and supplied to the DC load in accordance with the amount of stored charge in the secondary battery.

### BRIEF DESCRIPTION OF THE DRAWINGS

FIG. 1 is a diagram showing a power supply system according to an embodiment of the present invention.

FIG. 2 is a flowchart showing a procedure for supplying necessary power to a DC load according to the embodiment of the present invention.

FIG. 3 is a diagram showing a power supply system according to an embodiment of the present invention.

FIG. 4 is a diagram showing a power supply system according to an embodiment of the present invention.

FIG. 5 is a diagram showing a power supply system according to an embodiment of the present invention.

FIG. 6 is a diagram showing a power supply system according to an embodiment of the present invention.

FIG. 7 is a diagram showing a power supply system according to an embodiment of the present invention.

### EMBODIMENTS OF THE INVENTION

In the following, embodiments of the present invention are described in detail referring to the drawings. While a secondary battery is assumed to be a lithium-ion secondary battery in the following description, any other rechargeable battery capable of being charged and discharged may be used. For example, it is possible to use a nickel-hydrogen secondary battery, rechargeable nickel-cadmium battery, rechargeable lead battery, metal lithium-ion secondary battery, or the like. Further, in the following description, while a power supply system is assumed to include structures other than a switching device, a switching device may be considered as a power supply system.

In the following, like elements in all of the drawings are labeled with the same reference numeral, and explanations of those elements will not be repeated. Previously-mentioned reference numerals are referred to as necessary in the following description.

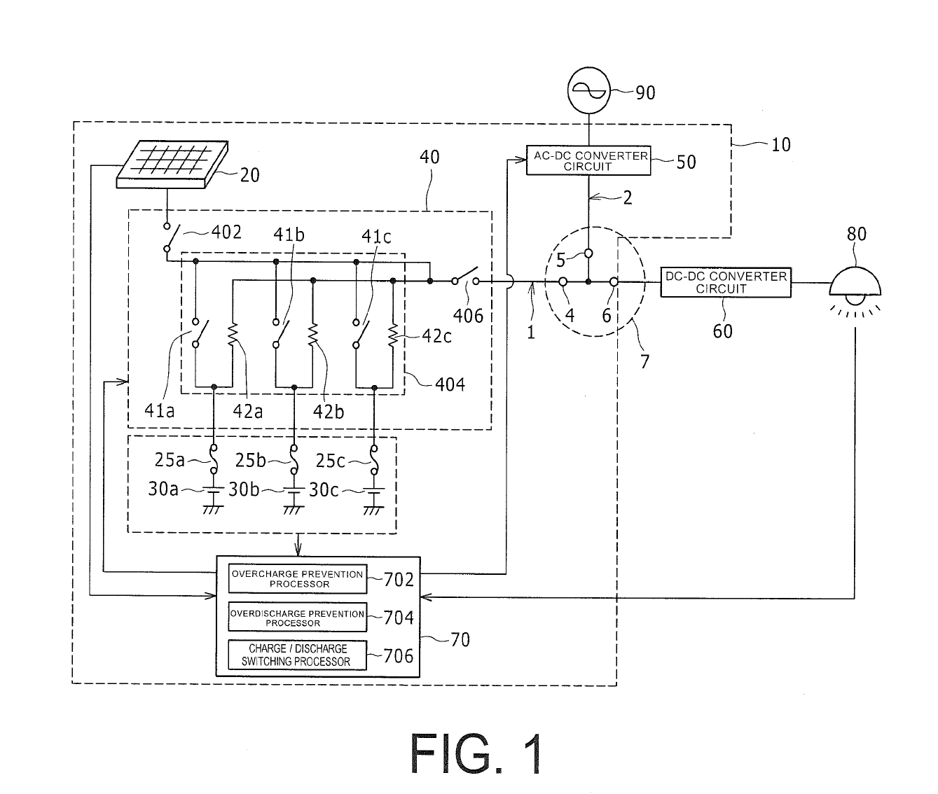

FIG. 1 is a diagram showing a power supply system 10. The power supply system 10 includes a solar cell module 20, breaker units 25a, 25b, 25c, lithium-ion secondary batteries 30a, 30b, 30c, switching device 40, AC-DC converter circuit 50, and control unit 70.

The solar cell module 20 is a photo-electric converter device that converts sunlight into electric power. An output terminal of the solar cell module 20 is connected to a first-side terminal of a first switch circuit 402. Power generated by the solar cell module 20 is DC power.

The lithium-ion secondary battery 30a has a positive side terminal connected to a second-side terminal of the breaker unit 25a, and a negative-side terminal which is grounded. The lithium-ion secondary battery 30b has a positive side terminal connected to a second-side terminal of the breaker unit 25b, and a negative-side terminal which is grounded. The lithium-ion secondary battery 30c has a positive side terminal connected to a second-side terminal of the breaker unit 25c, and a negative-side terminal which is grounded. The lithium-ion secondary batteries 30a, 30b, 30c are subjected to charge and discharge control so that the SOC (stage of charge) indicating a state of charge corresponding to an amount of stored charge falls within a predetermined range (from 20% to 80%, for example). Discharge power from the lithium-ion secondary batteries 30a, 30b, 30c is DC power. While it is explained above that the negative-side terminals of the lithium-ion secondary batteries 30a, 30b, 30c are grounded, the negative-side terminals can alternatively be non-grounded, as is obvious.

The lithium-ion secondary batteries 30a, 30b, 30c function as a DC power supply source for supplying power to a DC load 80 via a main power path 1.

The breaker units 25a, 25b, 25c are devices that shut down when it is necessary to protect the lithium-ion secondary batteries 30a, 30b, 30c. The breaker unit 25a has a first-side terminal connected to a parallel processing circuit unit 404, and the second-side terminal connected to the positive-side terminal of the lithium-ion secondary battery 30a. The breaker unit 25b has a first-side terminal connected to the parallel processing circuit unit 404, and the second-side terminal connected to the positive-side terminal of the lithium-ion secondary battery 30b. The breaker unit 25c has a first-side terminal connected to the parallel processing circuit unit 404, and the second-side terminal is connected to the positive-side terminal of the lithium-ion secondary battery 30c.

The switching device 40 is configured including a first switch circuit 402, the parallel processing circuit unit 404, and a second switch circuit 406.

The parallel processing circuit unit 404 is configured including switch circuits 41a, 41b, 41c and resistor elements 42a, 42b, 42c.

The switch circuit 41a is a switch having a first-side terminal connected to a second-side terminal of the first switch circuit 402 and a first-side terminal of the second switch circuit 406, and a second-side terminal connected to the first-side terminal of the breaker unit 25a. The switch circuit 41a may be configured using a field-effect transistor (FET), and in that case, it is desirable to use a parasitic diode having a cathode terminal connected to the first-side terminal of the switch circuit 41a and an anode terminal connected to the second-side terminal of the switch circuit 41a.

The resistor element 42a has a first-side terminal connected to a second-side terminal of the first switch circuit 402 and a first-side terminal of the second switch circuit 406, and a second-side terminal connected to the first-side terminal of the breaker unit 25a. In other words, the resistor element 42a is connected in parallel with the switch circuit 41a.

The switch circuit 41b is a switch having a first-side terminal connected to a second-side terminal of the first switch circuit 402 and a first-side terminal of the second switch circuit 406, and a second-side terminal connected to the first-side terminal of the breaker unit 25b. The switch circuit 41b may be configured using a field-effect transistor (FET), and in that case, it is desirable to use a parasitic diode having a cathode terminal connected to the first-side terminal of the switch circuit 41b and an anode terminal connected to the second-side terminal of the switch circuit 41b.

The resistor element 42b has a first-side terminal connected to a second-side terminal of the first switch circuit 402 and a first-side terminal of the second switch circuit 406, and a second-side terminal connected to the first-side terminal of the breaker unit 25b. In other words, the resistor element 42b is connected in parallel with the switch circuit 41b.

The switch circuit 41c is a switch having a first-side terminal connected to a second-side terminal of the first switch circuit 402 and a first-side terminal of the second switch circuit 406, and a second-side terminal connected to the first-side terminal of the breaker unit 25c. The switch circuit 41c may be configured using a field-effect transistor (FET), and in that case, it is desirable to use a parasitic diode having a cathode terminal connected to the first-side terminal of the switch circuit 41c and an anode terminal connected to the second-side terminal of the switch circuit 41c.

The resistor element 42c has a first-side terminal connected to a second-side terminal of the first switch circuit 402 and a first-side terminal of the second switch circuit 406, and a second-side terminal connected to the first-side terminal of the breaker unit 25c. In other words, the resistor element 42c is connected in parallel with the switch circuit 41c.

Effects achieved by the parallel processing circuit unit 404 are now described. During normal operation, the switch circuits 41a, 41b, 41c are controlled to the connected (“ON”) state by the control unit 70. The “ON” resistance values of the switch circuits 41a, 41b, 41c are smaller than the respective resistance values of the resistor elements 42a, 42b, 42c. Accordingly, when the first switch circuit 402 is also controlled to the connected state by the control unit 70, the power generated by the solar cell module 20 flows mainly through the switch circuits 41a, 41b, 41c so as to charge the respective lithium-ion secondary batteries 30a, 30b, 30c.

For example, prior to replacing the lithium-ion secondary battery 30b, the batteries have the same voltage value because they are connected in parallel. When, for example, the lithium-ion secondary battery 30b is replaced, the replaced lithium-ion secondary battery 30b may have a voltage value lower than the lithium-ion secondary batteries 30a, 30c, resulting in a voltage difference between the first-side terminal of the breaker unit 25b and the first-side terminals of the breaker units 25a, 25c. In that situation, in order to avoid having this lithium-ion secondary battery 30b with a different voltage value connected in parallel via the switch circuits 41a, 41b, 41c, the switch circuit 41b is disconnected by the control unit 70, for example. As a result, the power generated by the solar cell module 20 flows through the switch circuits 41a, 41c so as to charge the lithium-ion secondary batteries 30a, 30c. Further, because a voltage difference is generated between the first-side terminals of the breaker units 25a, 25c and the first-side terminal of the breaker unit 25b, electric current flows toward the breaker unit 25b side via the resistor elements 42a and 42b or the resistor elements 42c and 42b such that the lithium-ion secondary battery 30b becomes charged, and thus the above-noted voltage difference becomes reduced.

The first switch circuit 402 is a switch having a first-side terminal connected to the output terminal of the solar cell module 20, and the second-side terminal connected to the first-side terminals of the switch circuits 41a, 41b, 41c, the first-side terminals of the resistor elements 42a, 42b, 42c, and the first-side terminal of the second switch circuit 406. Switching control of the first switch circuit 402 is performed by the control unit 70. The first switch circuit 402 may be configured using a field-effect transistor (FET), and in that case, a parasitic diode is formed having an anode terminal connected to the second-side terminal of the first switch circuit 402 and a cathode terminal connected to the first-side terminal of the first switch circuit 402.

The second switch circuit 406 is a switch having a first-side terminal connected to the second-side terminal of the first switch circuit 402, the first-side terminals of the switch circuits 41a, 41b, 41c, and the first-side terminals of the resistor elements 42a, 42b, 42c. The second switch circuit 406 further includes a second-side terminal connected to an output terminal of the AC-DC converter circuit 50 via a main power path output-side terminal 4 and an auxiliary power path output-side terminal 5. The second-side terminal of the second switch circuit 406 is also connected to an input terminal of a DC-DC converter circuit via the main power path output-side terminal 4 and a common output terminal 6. Switching control of the second switch circuit 406 is performed by the control unit 70. The second switch circuit 406 may be configured using a field-effect transistor (FET), and in that case, a parasitic diode is formed having a cathode terminal connected to the first-side terminal and an anode terminal connected to the second-side terminal.

The AC-DC converter circuit 50 is a power converter circuit for converting system AC power, which is supplied by a system power supply 90 functioning as an AC power supply source, into system DC power. The AC-DC converter circuit 50 has an input terminal connected to the system power supply 90. Further, the AC-DC converter circuit 50 has an output terminal connected to the second-side terminal of the second switch circuit 406 via the auxiliary power path output-side terminal 5 and the main power path output-side terminal 4. The output terminal of the AC-DC converter circuit 50 is also connected to the input terminal of the DC-DC converter circuit 60 via the auxiliary power path output-side terminal and the common output terminal G. Activation and termination of operation of the AC-DC converter circuit 50 are controlled by the control unit 70. The system AC power supplied by the system power supply 90 is converted into the system DC power by the AC-DC converter circuit 50, and this system DC power is supplied to the DC load 80 via an auxiliary power path 2.

The DC-DC converter circuit 60 is a power converter circuit for converting the discharge power from the lithium-ion secondary batteries 30a, 30b, 30c or the system DC power output from the AC-DC converter circuit 50 into a voltage having a value suitable for the DC load 80. The DC-DC converter circuit 60 has an input terminal connected to the second-side terminal of the second switch circuit 406 via the common output terminal 6 and the main power path output-side terminal 4. The input terminal of the DC-DC converter circuit 60 is also connected to the output terminal of the AC-DC converter circuit 50 via the common output terminal 6 and the auxiliary power path output-side terminal 5. Further, the DC-DC converter circuit 60 has an output terminal connected to the DC load 80. The DC load 80 may be a lighting device operated by DC current, as shown in FIG. 1, or alternatively, the DC load 80 may be an electric device operated by DC current such as a personal computer or a copy machine.

The main power path output-side terminal 4 is terminal provided at an output-side end of the main power path 1. The auxiliary power path output-side terminal 5 is a terminal provided at an output-side end of the auxiliary power path 2. The common output terminal 6 is a terminal connected to the main power path output-side terminal 4 and the auxiliary power path output-side terminal 5. In this description, the main power path output-side terminal 4, the auxiliary power path output-side terminal 5, and the common output terminal 6 are collectively referred to as an output terminal unit 7. The output terminal unit 7 has the function to output the discharge power flowing through the main power path 1 and the system DC power flowing through the auxiliary power path 2 from one common output terminal 6 to the DC load 80.

The control unit 70 is configured including an overcharge prevention processor 702, overdischarge prevention processor 704, and charge/discharge switching processor 706. The control unit 70 has the function to perform connect/disconnect control of the first switch circuit 402 and the second switch circuit 406. By means of this function, the power generated by the solar cell module is once stored by charging the lithium-ion secondary batteries 30a, 30b, 30c, and subsequently discharged from the lithium-ion secondary batteries 30a, 30b, 30c as the discharge power and supplied to the DC load 80. Each constituent element of the control unit 70 may be configured by hardware or software.

The overcharge prevention processor 702 has the function to acquire the SOC of the lithium-ion secondary batteries 30a, 30b, 30c, and, in order to prevent the lithium-ion secondary batteries 30a, 30b, 30c from being overcharged, the function to disconnect the first switch circuit 402 when the SOC of at least one of the lithium-ion secondary batteries 30a, 30b, 30c becomes higher than an overcharge reference value (a third reference value, which is a reference value set for preventing the lithium-ion secondary batteries 30a, 30b, 30c from being overcharged, and may be set to 70%, for example). When the SOC of all of the lithium-ion secondary batteries 30a, 30b, 30c becomes lower than the overcharge reference value, the overcharge prevention processor 702 functions to perform control to again connect the first switch circuit 402. Although it is described above that the SOC is monitored to judge whether or not an overcharge is generated, the judgment can also be made based on factors other than the SOC. For example, it is possible to make the judgment based on the voltage values of the lithium-ion secondary batteries 30a, 30b, 30c. The state of overcharge referred to herein does not denote an overcharged state of the lithium-ion secondary batteries 30a, 30b, 30c themselves, but rather denotes a state of overcharge in terms of the system.

The overdischarge prevention processor 704 has the function to acquire the SOC of the lithium-ion secondary batteries 30a, 30b, 30c, and, for example, the function to disconnect the second switch circuit 406 after starting the operation of the AC-DC converter circuit 50 when the SOC of at least one of the lithium-ion secondary batteries 30a, 30b, 30c becomes lower than an overdischarge reference value (a first reference value, which is a reference value set for preventing the lithium-ion secondary batteries 30a, 30b, 30c from being overdischarged, and may be set to 30%, for example). When the SOC of all of the lithium-ion secondary batteries 30a, 30b, 30c becomes higher than the overdischarge reference value, the overdischarge prevention processor 704 functions to perform control to connect the second switch circuit 406 and then, for example, to terminate the operation of the AC-DC converter circuit 50. Although it is described above that the SOC is monitored to judge whether or not an overdischarge is generated, the judgment can also be made based on factors other than the SOC. For example, it is possible to make the judgment based on the voltage values of the lithium-ion secondary batteries 30a, 30b, 30c. The state of overdischarge referred to herein does not denote an overdischarged state of the lithium-ion secondary batteries 30a, 30b, 30c themselves, but rather denotes a state of overdischarge in terms of the system.

The charge/discharge switching processor 706 has the function to connect the first switch circuit 402 and the second switch circuit 406, for the purpose of causing the power generated by the solar cell module 20 to be stored by charging the lithium-ion secondary batteries 30a, 30b, 30c, and supplying the discharged power from the lithium-ion secondary batteries 30a, 30b, 30c to the DC load 80.

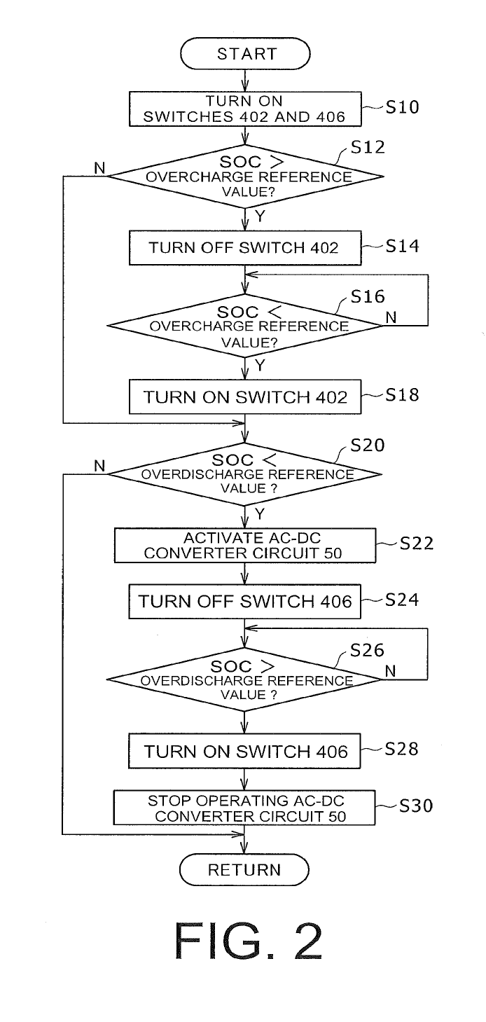

Effects achieved by the power supply system 10 having the above-described configuration are now described. FIG. 2 is a flowchart showing a procedure for supplying necessary power to the DC load 80 in the power supply system 10. In the initial state, operation of the AC-DC converter circuit 50 is stopped. First, the first switch circuit 402 and the second switch circuit 406 are placed in the connected state (S10). This step is performed by the function of the charge/discharge switching processor 706. As a result, the power generated by the solar cell module 20 serves to charge the lithium-ion secondary batteries 30a, 30b, 30c, and the discharge power from the lithium-ion secondary batteries 30a, 30b, 30c is supplied to the DC load 80. During this operation, if the amount of power generated by the solar cell module 20 is greater than the amount of power required by the DC load 80, the amount of stored charge in the lithium-ion secondary batteries 30a, 30b, 30c becomes increased by that excess amount of power (charge operation), and if the amount of power generated by the solar cell module 20 is smaller than the amount of power required by the DC load 80, the amount of stored charge in the lithium-ion secondary batteries 30a, 30b, 30c becomes decreased by that defecit amount of power (discharge operation).

Next, the SOC of the lithium-ion secondary batteries 30a, 30b, 30c is acquired, and a judgment is made as to whether or not the SOC of at least one of the batteries is higher than the overcharge reference value (S12). This step is performed by the function of the overcharge prevention processor 702. If it is judged in step S12 that the SOC of all of the batteries is lower than the overcharge reference value, the process proceeds to S20.

If it is judged in step S12 that the SOC of at least one of the lithium-ion secondary batteries 30a, 30b, 30c is higher than the overcharge reference value, the first switch circuit 402 is placed in the disconnected state (S14). This step is performed by the function of the overcharge prevention processor 702. As a result, the power generated by the solar cell module 20 is not supplied to the lithium-ion secondary batteries 30a, 30b, 30c, such that an overcharged state of the lithium-ion secondary batteries 30a, 30b, 30c can be prevented.

Subsequent to step S14, the SOC of the lithium-ion secondary batteries 30a, 30b, 30c is acquired, and a judgment is made as to whether or not the SOC of all of the batteries is lower than the overcharge reference value (S16). This step is performed by the function of the overcharge prevention processor 702. If it is judged in step S16 that the SOC of at least one of the batteries is higher than the overcharge reference value, the process returns to S16 after allowing a predetermined period of time to elapse.

If it is judged in step S16 that the SOC of all of the lithium-ion secondary batteries 30a, 30b, 30c is lower than the overcharge reference value, the first switch circuit 402 is placed in the connected state (S18). This step is performed by the function of the overcharge prevention processor 702. As a result, the power generated by the solar cell module 20 is again once stored by charging the lithium-ion secondary batteries 30a, 30b, 30c.

In step S20, the SOC of the lithium-ion secondary batteries 30a, 30b, 30c is acquired, and if it is judged that the SOC of at least one of the batteries is lower than the overdischarge reference value, the operation of the AC-DC converter circuit 50 is started (S22), and subsequently the second switch circuit 406 is placed in the disconnected state (S24). These steps are performed by the function of the overdischarge prevention processor 704. As a result, the discharge power from the lithium-ion secondary batteries 30a, 30b, 30c is not supplied to the DC load 80, such that an overdischarged state of the lithium-ion secondary batteries 30a, 30b, 30c can be prevented. After step S24, the process proceeds to S26.

If it is judged in step S20 that the SOC of all of the lithium-ion secondary batteries 30a, 30b, 30c is higher than the overdischarge reference value, the process proceeds to the “RETURN” step, from which the process returns to the first “START” step.

In step S26, the SOC of the lithium-ion secondary batteries 30a, 30b, 30c is acquired, and a judgment is made as to whether or not the SOC of all of the batteries is higher than the overdischarge reference value (S26). This step is performed by the function of the overdischarge prevention processor 704. If it is judged in step S26 that the SOC of at least one of the batteries 30a, 30b, 30c is lower than the overdischarge reference value, the process returns to S26 after allowing a predetermined period of time to elapse.

If it is judged in step S26 that the SOC of all of the batteries is higher than the overdischarge reference value, the second switch circuit 406 is placed in the connected state (S28), and subsequently the operation of the AC-DC converter circuit 50 is stopped (S30). These steps are performed by the function of the overdischarge prevention processor 704. After step S30, the process proceeds to the “RETURN” step. As a result, the discharge power from the lithium-ion secondary batteries 30a, 30b, 30c is again supplied to the DC load 80.

As described above, according to the power supply system 10, the power generated by the solar cell module 20 is once stored by charging the lithium-ion secondary batteries 30a, 30b, 30c, and subsequently supplied as the discharge power from the lithium-ion secondary batteries 30a, 30b, 30c to the DC load 80. During this operation, if the amount of power generated by the solar cell module 20 is greater than the amount of power required by the DC load 80, the amount of stored charge in the lithium-ion secondary batteries 30a, 30b, 30c becomes increased by that excess amount of power (charge operation), and if the amount of power generated by the solar cell module 20 is smaller than the amount of power required by the DC load 80, the amount of stored charge in the lithium-ion secondary batteries 30a, 30b, 30c becomes decreased by that deficit amount of power (discharge operation). When the discharge power supplied via the main power path 1 cannot satisfy the power requirement of the DC load 80, the DC system power output from the AC-DC converter circuit 50 is supplied to the DC load 80 via the auxiliary power path 2. In this way, according to the power supply system 10, energy such as the power generated by the solar cell module 20 can be utilized effectively.

Further, according to the power supply system 10, when the SOC of the lithium-ion secondary batteries 30a, 30b, 30c becomes higher than the overcharge reference value, by disconnecting the first switch circuit 402, an overcharged state can be prevented. In addition, when the SOC of the lithium-ion secondary batteries 30a, 30b, 30c becomes lower than the overdischarge reference value, by disconnecting the second switch circuit 406, an overdischarged state can be prevented. When disconnecting the second switch circuit 406, the operation of the AC-DC converter circuit is started before the second switch circuit 406 is disconnected. When subsequently connecting the second switch circuit 406 again, the second switch circuit 406 is connected before the operation of the AC-DC converter circuit is stopped. Accordingly, even when switching between the supply of power from the main power path 1 to the DC load 80 and the supply of power from the auxiliary power path 2 to the DC load 80, as an overlap period is provided during which power is supplied to the DC load 80 from both of the main power path 1 and the auxiliary power path 2, disruptions in supply of power to the DC load 80 during the switching operation can be prevented.

While it is explained above that, according to the power supply system 10, the AC-DC converter circuit 50 is activated before disconnecting the second switch circuit 406 and is stopped after connecting the second switch circuit 406, the AC-DC converter circuit 50 may alternatively be operated at all times.

Further, it is explained above that, according to the power supply system 10, in the case in which the second switch circuit 406 is to be disconnected when the SOC of the lithium-ion secondary batteries 30a, 30b, 30c becomes decreased, the AC-DC converter circuit 50 is activated immediately before disconnecting the second switch circuit 406. However, the AC-DC converter circuit 50 may alternatively be activated when the SOC becomes lower than a second reference value which is smaller than the overcharge reference value and greater than the overdischarge reference value (the second reference value is a value including a sufficient margin for more reliably preventing an overdischarged state of the lithium-ion secondary batteries 30a, 30b, 30c, and may be set to 40%, for example).

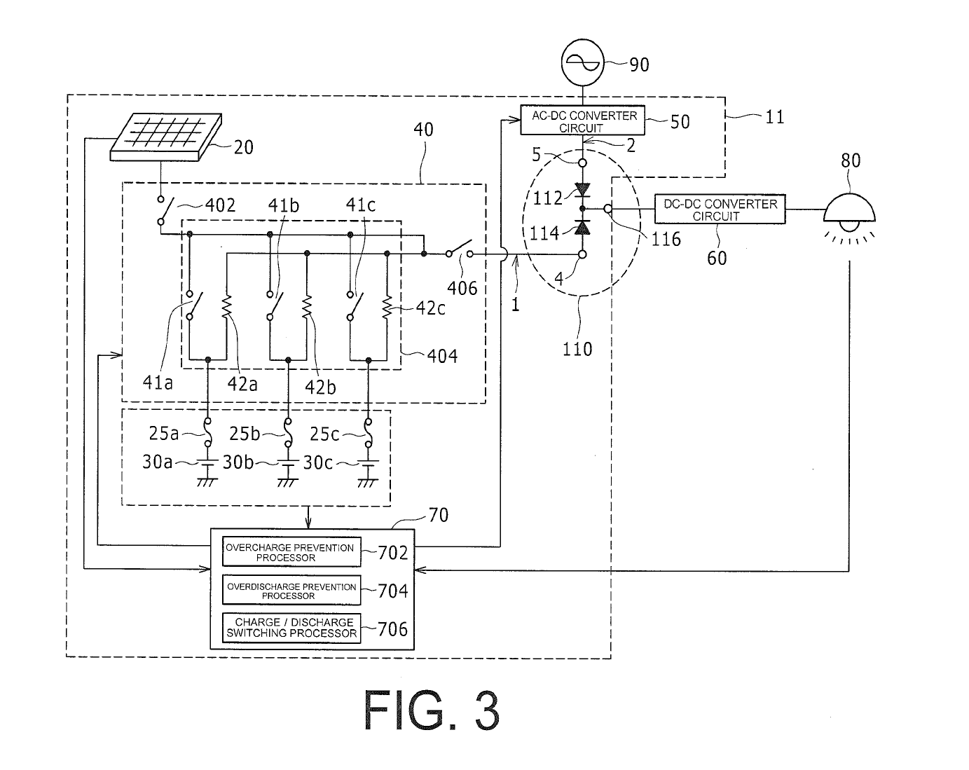

Next described is a power supply system 11. FIG. 3 is a diagram showing the power supply system 11. As the power supply system 11 has a configuration almost identical to the power supply system 10 and the differences reside in the output terminal unit 110, the following description is given focusing on the output terminal unit 110.

The output terminal unit 110 is configured including a first diode 114, a second diode 112, and a common output terminal 116. The output terminal unit 110 has the function to output the discharge power flowing through the main power path 1 and the system DC current flowing through the auxiliary power path 2 from one common output terminal 116 to the DC load 80.

The first diode 114 has an anode terminal connected to the main power path output-side terminal 4, and a cathode terminal connected to a cathode terminal of the second diode 112 and the common output terminal 116.

The second diode 112 has an anode terminal connected to the auxiliary power path output-side terminal 5, and a cathode terminal connected to the cathode terminal of the first diode 114 and the common output terminal 116.

According to the above-described power supply system 11, the power generated by the solar cell module 20 is first stored by charging the lithium-ion secondary batteries 30a, 30b, 30c, and subsequently supplied as the discharge power from the lithium-ion secondary batteries 30a, 30b, 30c to the DC load 80. During this operation, if the amount of power generated by the solar cell module 20 is greater than the amount of power required by the DC load 80, the amount of stored charge in the lithium-ion secondary batteries 30a, 30b, 30c becomes increased by that excess amount of power (charge operation), and if the amount of power generated by the solar cell module 20 is smaller than the amount of power required by the DC load 80, the amount of stored charge in the lithium-ion secondary batteries 30a, 30b, 30c becomes decreased by that deficit amount of power (discharge operation). When the output voltage of the lithium-ion secondary batteries 30a, 30b, 30c, or in other words, the potential of the main power path 1, is higher than the potential of the auxiliary power path 2, power is supplied from the main power path 1 via the first diode 114 to the DC load 80. Further, when the potential of the main power path 1 becomes lower than the potential of the auxiliary power path 2 by continued discharge from the lithium-ion secondary batteries 30a, 30b, 30c, power is supplied from the auxiliary power path 2, instead of the main power path 1, via the second diode 112 to the DC load 80. With this arrangement, when the discharge power flowing through the main power path 1 cannot satisfy the power requirement of the DC load 80, the DC system power output from the AC-DC converter circuit 50 is supplied to the DC load 80 via the auxiliary power path 2. In this way, according to the power supply system 11, energy such as the power generated by the solar cell module 20 can be utilized effectively.

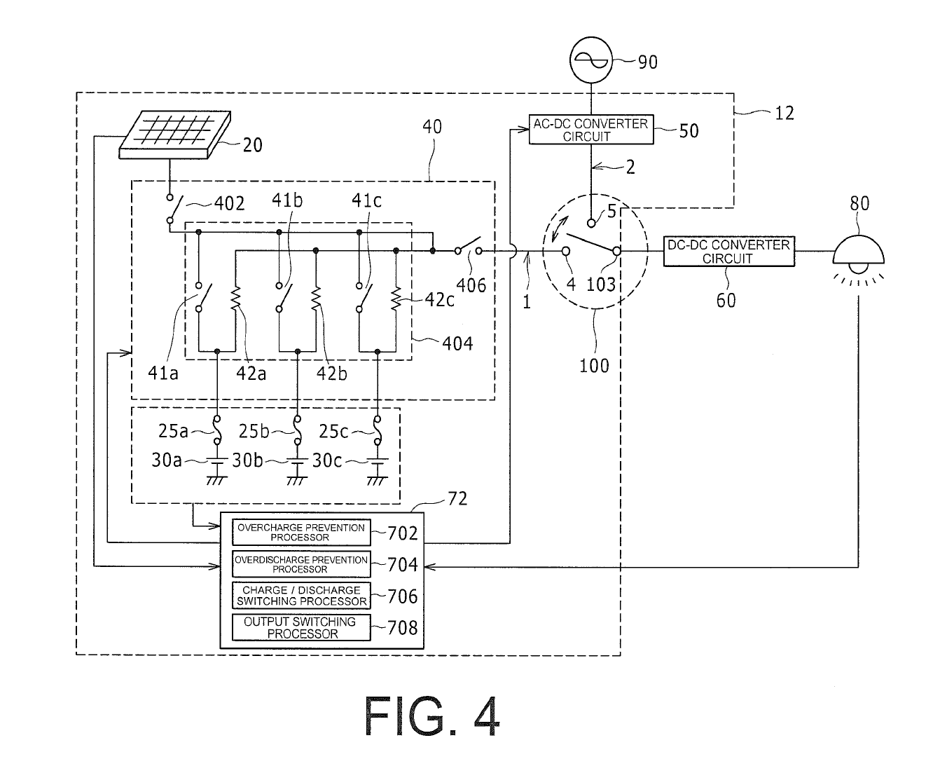

Next described is a power supply system 12. FIG. 4 is a diagram showing the power supply system 12. As the power supply system 12 has a configuration almost identical to the power supply system 10 and the differences only reside in the output terminal unit 100 and an output switching processor 708 provided in the control unit 72, the following description is given focusing on the output terminal unit 100 and the output switching processor 708 in the control unit 72.

The output terminal unit 100 has the function to switch, as a result of control by the control unit 72, the connection of the input side of the common output terminal 103 to either one of the main power path output-side terminal 4 and the auxiliary power path output-side terminal 5.

The output switching processor 708 in the control unit 72 causes the input side of the common output terminal 103 to be connected to the main power path output-side terminal 4 when the SOC of all of the lithium-ion secondary batteries 30a, 30b, 30c is higher than the overdischarge reference value. When the SOC of at least one of the lithium-ion secondary batteries 30 is lower than the overdischarge reference value, the output switching processor 708 causes the input side of the common output terminal 103 to be connected to the auxiliary power path output-side terminal 5. Further, the output switching processor 708 establishes a connection to the auxiliary power path output-side terminal 5 when it becomes necessary to disconnect the second switch circuit 406, and when the second switch circuit 406 is to be connected again, the output switching processor 708 establishes a connection to the main power path output-side terminal 4.

According to the above-described power supply system 12, the power generated by the solar cell module 20 is once stored by charging the lithium-ion secondary batteries 30a, 30b, 30c, and subsequently supplied as the discharge power from the lithium-ion secondary batteries 30a, 30b, 30c to the DC load 80. During this operation, if the amount of power generated by the solar cell module 20 is greater than the amount of power required by the DC load 80, the amount of stored charge in the lithium-ion secondary batteries 30a, 30b, 30c becomes increased by that excess amount of power (charge operation), and if the amount of power generated by the solar cell module 20 is smaller than the amount of power required by the DC load 80, the amount of stored charge in the lithium-ion secondary batteries 30a, 30b, 30c becomes decreased by that deficit amount of power (discharge operation). When the discharge power flowing through the main power path 1 cannot satisfy the power requirement of the DC load 80, the DC system power output from the AC-DC converter circuit 50 is supplied to the DC load 80 via the auxiliary power path 2. In this way, according to the power supply system 12, energy such as the power generated by the solar cell module 20 can be utilized effectively.

According to the power supply systems 10, 11, 12, the discharge power flowing through the main power path 1 and the DC system power flowing through the auxiliary power path 2 can be supplied to the DC load 80 from one common output terminal 6, 103, 116. With this arrangement, the common output terminals 6, 103, 116 can each be connected to the DC-DC converter circuit 60 with one power line. Accordingly, even when the DC load 80 is disposed in a location away from the power supply systems 10, 11, 12, the number of wiring lines from the systems can be minimized. Furthermore, by placing the DC-DC converter circuit 60 in a location close to the DC load 80, it becomes possible to supply power having a voltage higher than a voltage suitable for the DC load 80, such that power loss in wiring lines, which becomes more noticeable when the power supply line is long, can be reduced.

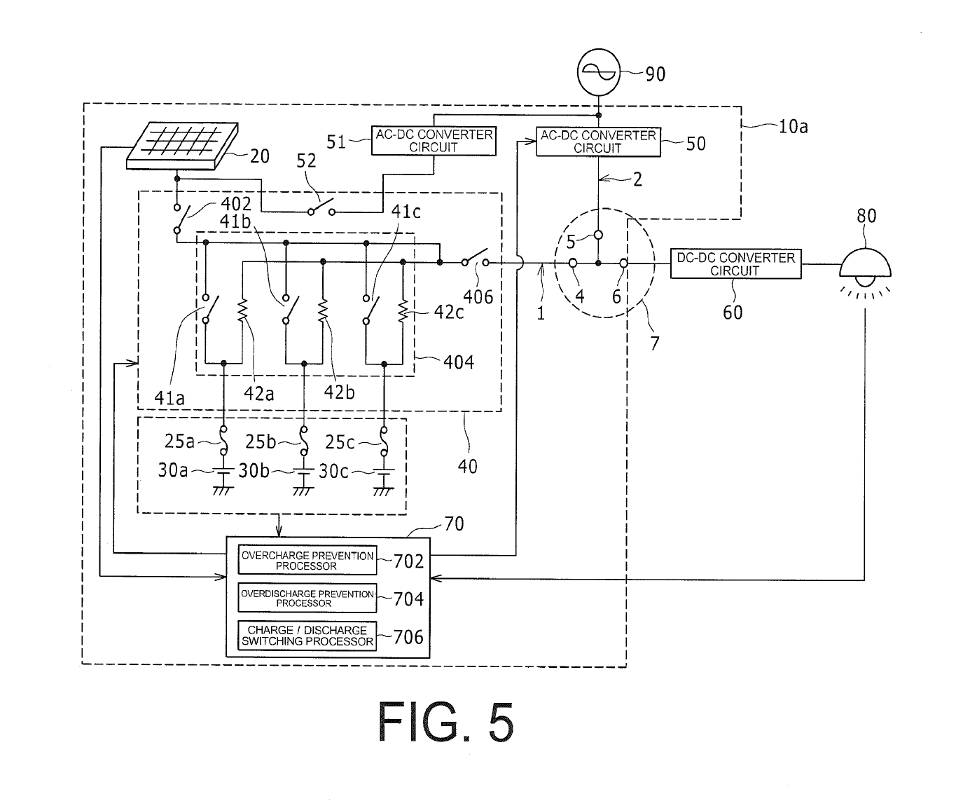

Next described is a power supply system 10a, which is a variant of the power supply system 10. FIG. 5 is a diagram showing the power supply system 10a. As the power supply system 10a has a configuration almost identical to the power supply system 10 and the differences reside in that an AC-DC converter circuit 51 and a third switch circuit 52 are provided, the following description is given focusing on those differences.

The AC-DC converter circuit 51 is a power converter circuit that converts the system AC power, which is supplied from the system power supply 90 functioning as an AC power supply source, into the system DC power, and that is capable of outputting a current having a predetermined current value (10A, for example). The AC-DC converter circuit 51 has an input terminal connected to the system power supply 90, and an output terminal connected to the first-side terminal of the third switch circuit 52. The value of current output from the AC-DC converter circuit 51 is measured using an ammeter, not shown.

The third switch circuit 52 is a switch having the first-side terminal connected to the output terminal of the AC-DC converter circuit 51, and a second-side terminal connected to the output terminal of the solar cell module 20 and the first-side terminal of the first switch circuit 402. The third switch circuit 52 has the function to be connected when the value of current output from the AC-DC converter circuit 51 is greater than a predetermined threshold value (4A, for example), and to be disconnected when the current value is less than the predetermined threshold value. The third switch circuit 52 may be configured using a field-effect transistor (FET), and in that case, a parasitic diode is formed having a cathode terminal connected to the second-side terminal and an anode terminal connected to the first-side terminal.

Effects achieved by the power supply system 10a having the above-described configuration are now described. In the power supply system 10a, when the power generated by the solar cell module 20 is to be stored by charging the lithium-ion secondary batteries 30a, 30b, 30c, the first switch circuit 402 is connected as a result of control by the control unit 70. When the lithium-ion secondary batteries 30a, 30b, 30c are to be charged using the system power supply 90, the third switch circuit 52 is connected.

The AC-DC converter circuit 51 is configured such that a reverse current flows when a voltage is applied from outside on the output side. In a case in which an FET is employed in the first switch circuit 402 (the FET being a parasitic diode having a cathode terminal located on the solar cell module 20 side and an anode terminal located on the lithium-ion secondary batteries 30a, 30b, 30c side), or in a case in which power is not generated by the solar cell module 20 while the first switch circuit 402 is connected at times such as during a period in which charging operation by the solar cell module 20 is possible, a reverse current may flow from the lithium-ion secondary batteries 30a, 30b, 30c toward the AC-DC converter circuit 51 side via the parasitic diodes of the switch circuits 41a, 41b, 41c and the switch circuits 41a, 41b, 41c themselves. As a result, unintended discharging from the lithium-ion secondary batteries 30a, 30b, 30c may occur, and it may become impossible to discharge to the DC load 80 when necessary.

Furthermore, a reverse current toward the AC-DC converter circuit 51 may also flow during power generation by the solar cell module 20, such that the power generated by the solar cell module 20 cannot be utilized effectively. In addition, when the first switch circuit 402 is disconnected, a large reverse current or high voltage may be applied to the output side of the AC-DC converter circuit 51 due to characteristics of the solar cell module 20, and this may cause damages to the AC-DC converter circuit 51.

In this situation, for example, consideration may be given to providing, in place of the third switch circuit 52, a diode connected such that an anode terminal is located on the AC-DC converter circuit 51 side and a cathode terminal is located on the first switch circuit 402 side. However, with this arrangement, constant loss would be generated within the diode during charging by the AC-DC converter circuit 51. Therefore, the present embodiment confirms absence of reverse current toward the AC-DC converter circuit 51 by determining that the value of current from the AC-DC converter circuit 51 side is greater than a predetermined threshold value, and then the third switch circuit 52 is connected. Here, it is desirable to select the predetermined threshold value such that the current of the generated power from the solar cell module 20 does not flow in a reverse direction toward the AC-DC converter circuit 51 side when the first switch circuit 402 is disconnected. This is explained below in further detail.

The maximum value of the output voltage from the AC-DC converter circuit 51 is set to the maximum allowable voltage of the lithium-ion secondary batteries 30a, 30b, 30c, so as to avoid an overcharged state of the lithium-ion secondary batteries 30a, 30b, 30c. Meanwhile, from the aspect of current/voltage characteristics, the solar cell module 20 is desirably selected such that, for example, 60 to 80% of the maximum output operation voltage of the solar cell module 20 equals the maximum allowable voltage of the lithium-ion secondary batteries 30a, 30b, 30c. A reverse current toward the AC-DC converter circuit 51 would be generated when the output voltage from the solar cell module 20 becomes higher than the maximum output voltage of the AC-DC converter circuit 51, and this current from the solar cell module 20 depends on the current/voltage characteristics of the solar cell module 20. When the first switch circuit 402 is disconnected while charging current is being generated from the solar cell module 20 and from the AC-DC converter circuit 51, the generated current from the solar cell module would flow toward the AC-DC converter circuit 51. Considering this situation, the threshold value is desirably set higher than or equal to the rated current of the solar cell module 20 when the maximum voltage is generated by the AC-DC converter circuit 51. With this arrangement, even when a reverse current from the solar cell module 20 is generated, the reverse current would be unlikely to immediately flow toward the AC-DC converter circuit 51. In practice, in a case in which the response speed for disconnecting the third switch circuit 52 is high, the threshold value can be set lower than the above-noted rated current. More specifically, in the present embodiment, the threshold value is set to 4A, for example, considering factors such as the maximum allowable voltage of the lithium-ion secondary batteries 30a, 30h, 30c.

According to the configuration of the power supply system 10a as described above, when the value of current output from the AC-DC converter circuit 51 becomes smaller than the predetermined threshold value (4A, for example), the third switch circuit 52 is caused to be disconnected. Accordingly, even if any reverse current flow from the solar cell module 20 or the lithium-ion secondary batteries 30a, 30b, 30c is generated toward the AC-DC converter circuit 51 side, the third switch circuit 52 is in the disconnected state. In other words, the configuration of the power supply system 10a makes it possible to prevent a reverse current from flowing from the solar cell module 20 or the lithium-ion secondary batteries 30a, 30b, 30c to the AC-DC converter circuit 51.

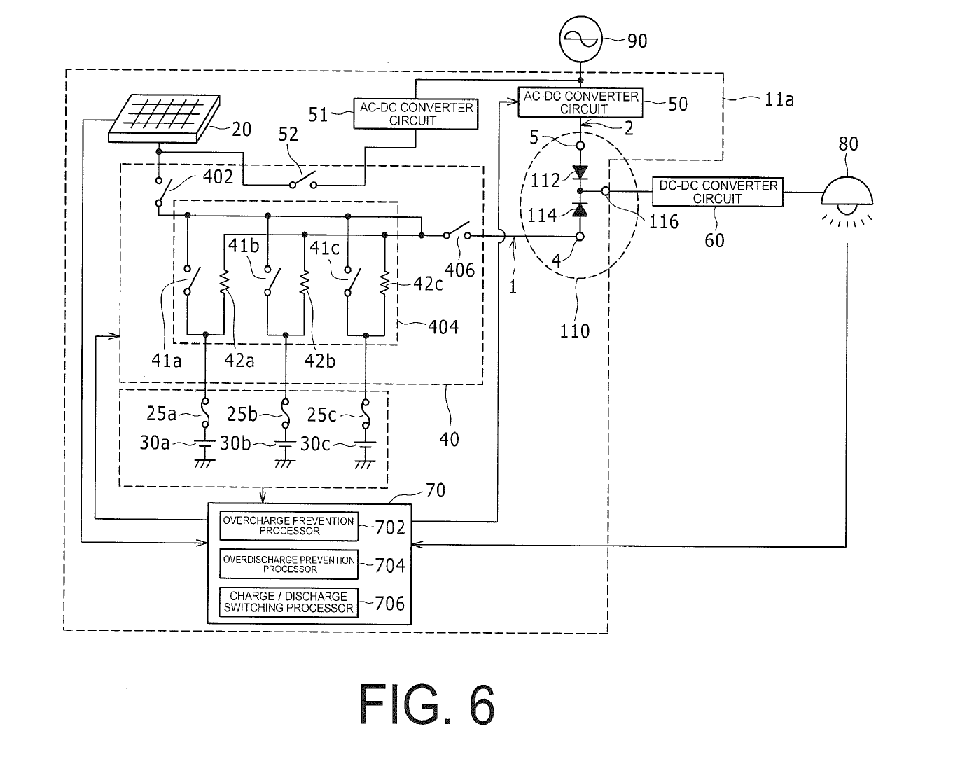

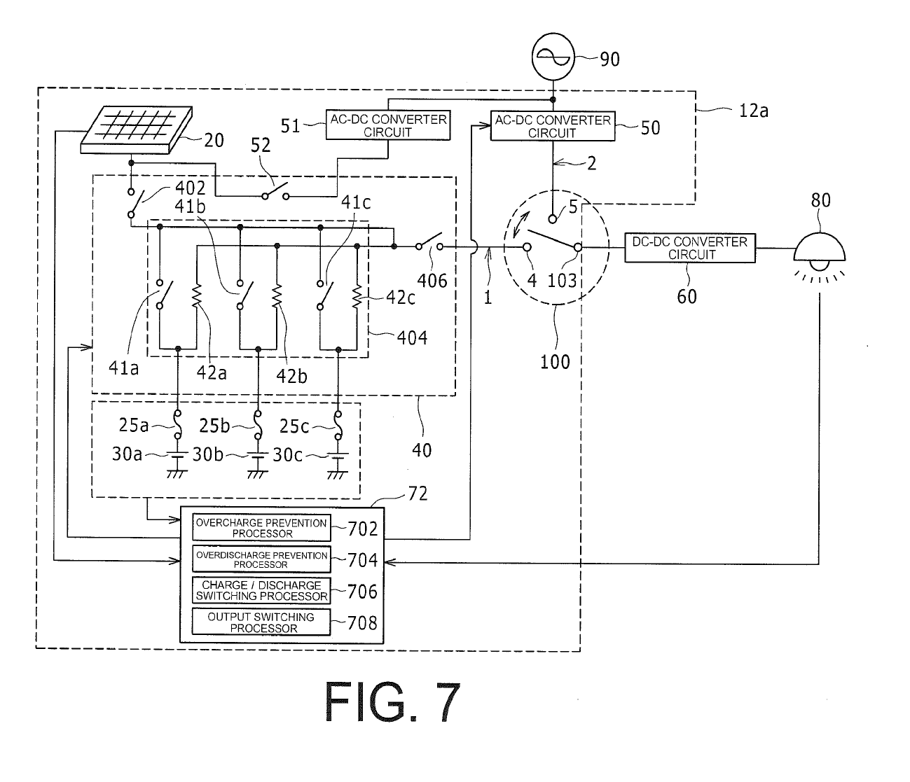

Next described are a power supply system 11a which is a variant of the power supply system 11, and a power supply system 12a which is a variant of the power supply system 12. FIG. 6 is a diagram showing the power supply system 11a. FIG. 7 is a diagram showing the power supply system 12a. The power supply system 11a has a configuration almost identical to the power supply system 11, and the differences reside in that an AC-DC converter circuit 51 and a third switch circuit 52 are provided. Further, the power supply system 12a has a configuration almost identical to the power supply system 12, and the differences reside in that an AC-DC converter circuit 51 and a third switch circuit 52 are provided. In addition, as the AC-DC converter circuit 51 and the third switch circuit 52 of the power supply system 11a and the power supply system 12a are identical to the AC-DC converter circuit 51 and the third switch circuit 52 of the power supply system 10a, detailed descriptions are not repeated.

As explained above, as the power supply systems 11a and 12a are provided with structures identical to the AC-DC converter circuit 51 and the third switch circuit 52 of the power supply system 10a, the power supply systems 11a, 12a are capable of converting the AC system power from the system power supply 90 into the DC system power and supplying the DC system power to the lithium-ion secondary batteries 30a, 30b, 30c. According to the configurations of the power supply systems 11a, 12a, when the value of current output from the AC-DC converter circuit 51 becomes smaller than a predetermined threshold value (4A, for example), the third switch circuit 52 is caused to be disconnected. Accordingly, even if any reverse current flow from the solar cell module 20 or the lithium-ion secondary batteries 30a, 30b, 30c is generated toward the AC-DC converter circuit 51 side, the third switch circuit 52 is in the disconnected state. In other words, the configuration of the power supply system 10a makes it possible to prevent a reverse current from flowing from the solar cell module 20 or the lithium-ion secondary batteries 30a, 30b, 30c to the AC-DC converter circuit 51.

With respect to each element in the power supply systems 10, 10a, 11, 11a, 12, 12a that requires power, such as control circuits included in the lithium-ion secondary batteries 30a, 30b, 30c, the switching device 40, and the control units 70, 72, power is supplied from a system operation power supply unit which supplies power for the overall system. The system operation power supply unit is a power supply device that produces output power using the generated power from the solar cell module 20 and the system power from the system power supply 90. In the power supply systems 10, 10a, 11, 11a, 12, 12a, the AC-DC converter circuit 50 is operated by means of the system power from the system power supply 90 instead of the power from the system operation power supply unit, and is detached from the system operation power supply unit. With this arrangement, the AC-DC converter circuit 50 operated by the system power from the system power supply 90 can stably supply power to the DC load 80 even when power supply from the system operation power supply unit is stopped and the system experiences a power failure.

Further, in the power supply systems 10, 10a, 11, 11a, 12, 12a, the maximum value of the discharge power supplied from the lithium-ion secondary batteries 30a, 30b, 30c is 1.5 kW, for example. Meanwhile, the maximum value of the power supplied from the AC-DC converter circuit 50 is 3 kW, for example, which is double the value of the power supplied from the lithium-ion secondary batteries 30a, 30b, 30c. When, for example, an electronic instrument requiring power of 1.5 kW is connected as the DC load 80, power can be supplied to the DC load 80 from either of the lithium-ion secondary batteries 30a, 30b, 30c and the AC-DC converter circuit 50. However, when, for example, an electronic instrument requiring power of 3 kW is connected as the DC load 80, sufficient power cannot be provided by the discharge power of the lithium-ion secondary batteries 30a, 30b, 30c, such that power is supplied to the DC load 80 from the AC-DC converter circuit 50. With this arrangement, the value of maximum rated power of the discharge power supplied from the lithium-ion secondary batteries 30a, 30b, 30c can be suppressed, and at the same time, even when an electronic instrument requiring power of a value greater than the value of power supplied from the lithium-ion secondary batteries 30a, 30b, 30c is connected as the DC load 80, power can be supplied stably using the system power from the system power supply 90. By suppressing the maximum rated power value of the discharge power supplied from the lithium-ion secondary batteries 30a, 30b, 30c, it is possible to extend the life of the lithium-ion secondary batteries 30a, 30b, 30c. As such, the allowable range of use of the DC load 80 can be enlarged, and a system having a long period of use can be created.

While it is explained above that in the power supply systems 10, 10a, 11, 11a, 12, 12a, the first switch circuit 402 functions as a switch for protection against overcharge and is provided commonly for the lithium-ion secondary batteries 30a, 30b, 30c, the switch circuit may alternatively be provided for each of the lithium-ion secondary batteries 30a, 30b, 30c. For example, the switch circuits may be provided by connecting in series with the respective switch circuits 41a, 41b, 41c. Further, while it is explained above that the second switch circuit 406 functions as a switch for protection against overdischarge and is provided commonly for the lithium-ion secondary batteries 30a, 30b, 30c, the switch circuit may alternatively be provided for each of the lithium-ion secondary batteries 30a, 30b, 30c. For example, the switch circuits may be provided by connecting in series with the respective switch circuits 41a, 41b, 41c. Further, the above-described switch circuits 41a, 41b, 41c may alternatively be configured using two FETs forming a reverse parasitic diode. Furthermore, the above-described third switch circuit 52 may alternatively be provided on the solar cell module 20 side.

1. A power supply system output circuit, comprising:
a first power path for supplying discharge power being discharged from a plurality of secondary batteries as a first DC power;
a second power path for supplying a second DC power obtained by converting AC power from an AC power supply source using an AC-DC converter circuit; and
an output terminal unit which is connected to the first power path and the second power path and which includes a common output terminal for supplying the first DC power or the second DC power to a DC load via a DC-DC converter circuit, wherein
the first power path supplies the first DC power to the output terminal unit when an amount of stored charge in at least one of the plurality of secondary batteries is greater than a predetermined first reference value, and
the second power path supplies the second DC power to the output terminal unit when the amount of stored charge in at least one of the plurality of secondary batteries is less than the first reference value.

2. The power supply system output circuit according to claim 1, wherein the output terminal unit comprises:
a first diode having an anode terminal connected to an output terminal side of the plurality of secondary batteries, and a cathode terminal connected to the common output terminal; and
a second diode having an anode terminal connected to an output terminal side of the AC-DC converter circuit, and a cathode terminal connected to the common output terminal.

3. The power supply system output circuit according to claim 1, wherein the output unit comprises a connection switching unit that is switched so that:
when the amount of stored charge in at least one of the plurality of secondary batteries is greater than the first reference value, the common output terminal is connected to an output terminal side of the plurality of secondary batteries; and
when the amount of stored charge in at least one of the plurality of secondary batteries is less than the first reference value, the common output terminal is connected to an output terminal side of the AC-DC converter circuit.

4. The power supply system output circuit according to claim 1, wherein
the common output terminal of the output terminal unit is connected to both of an output terminal side of the plurality of secondary batteries and an output terminal side of the AC-DC converter circuit;
the power supply system output circuit further comprises a switch circuit for disconnecting or connecting a path for performing discharge from the plurality of secondary batteries to the DC load; and
when the amount of stored charge in at least one of the plurality of secondary batteries becomes less than the first reference value, the switch circuit is disconnected after operation of the AC-DC converter circuit is started.

5. The power supply system output circuit according to claim 4, wherein, subsequent to disconnecting the switch circuit after operation of the AC-DC converter circuit is started when the amount of stored charge in at least one of the plurality of secondary batteries becomes less than the first reference value,
when the amount of stored charge in at least one of the plurality of secondary batteries becomes greater than the first reference value, the operation of the AC-DC converter circuit is stopped after the switch circuit is connected.

6. The power supply system output circuit according to claim 1, wherein
elements other than the AC-DC converter circuit are operated by means of power supplied from a system operation power supply unit; and
the AC-DC converter circuit is operated by means of power supplied from the AC power supply source via a path different from a power supply path from the system operation power supply unit to the elements other than the AC-DC converter circuit.

7. The power supply system output circuit according to claim 1, wherein
power supplied from the AC-DC converter circuit to the DC load is greater than power supplied from the plurality of secondary batteries to the DC load.
